(19) United States
(12) Patent Application Publication
(10) Pub. No.: US 2008/0153501 A1
(43) Pub. Date: Jun. 26, 2008

(54) SMART ANTENNA FOR COMMON CHANNEL INCREMENTAL REDUNDANCY

(75) Inventors: John M. Harris, Chicago, IL (US); Matt J. Dillon, Hawthorn Woods, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/613,526

(22) Filed: Dec. 20, 2006

(51) Int. Cl. H04Q 7/20; H04B 1/38

(52) U.S. Cl. 455/446; 455/562.1

(57) ABSTRACT

A system includes a base station transceiver to provide wireless service to a wireless coverage area, determine a low coverage region of the wireless coverage area, and generate incremental redundant transmissions comprising initial transmissions and subsequent transmissions to be transmitted. A smart antenna transmits the initial transmissions according to wide beam width smart antenna settings, and points at the low coverage region when transmitting the subsequent transmissions. The first transmissions and the second transmissions are transmitted on at least one of: a dedicated channel without fast feedback Automatic Request for Retransmission (“ARQ”), and a channel having negative acknowledgment (“NAK”) feedback.

### TECHNICAL FIELD

This invention relates generally to a smart antenna utilized for common channel redundancy in a wireless broadcast system.

### BACKGROUND

Coverage and system capacity for broadcast services is important for wireless services and has an impact on services such as mobile station pages, group calls, and streaming video. In the event that data, such as video data, is to be broadcast to a plurality of mobile stations within a given wireless coverage area, a base station transceiver may periodically broadcast a paging message to each of the mobile stations. An incremental redundancy method is often utilized for transmitting the paging message.

Incremental redundancy increases capacity and is used on High Rate Packet Data (“HRPD”) paging channels where the same message is transmitted in each of 16 consecutive subframes. A smart antenna may be utilized by the base station transceiver to broadcast messages or pages. A smart antenna is a system of antenna arrays with smart signal processing algorithms that are used to identify the direction of arrival (“DOA”) of the signal, and that use this information to calculate beamforming vectors to track and locate the antenna beam on the mobile station/target.

The same smart antenna settings are typically used over the duration of the 16 subframe transmissions according to current incremental redundancy methods. This, however, results in the use of more than enough power for mobile stations near the base station transceiver. In other words, for mobile stations in close proximity to the base station transceiver, the transmissions are received with more than enough power to be decoded. There is often, however, insufficient or marginal power for a mobile station near the sector edge or in another area of low coverage, such as a geographical valley, leading to overall poor coverage for the service area, as mobiles near the sector edge or in the other low coverage areas may not be able to decode the transmissions.

Current systems are therefore deficient because the same antenna settings are used for each of the transmissions. This can result in some mobile stations in the low coverage areas not being able to successfully receive and decode the transmissions.

Missed pages can result in mobile stations not receiving notifications or calls in a timely manner, degrading the user experience. Increasing Paging Channel (“PCH”)/overhead channel power/redundancy is expensive from a capacity perspective and smart antennas are being deployed at significant expense to operators. The smart antennas are not, however, currently achieving the full possible impact or benefit.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a wireless system according to at least one embodiment of the present invention;

FIG. 2 illustrates a base station transceiver according to at least one embodiment of the present invention;

FIG. 3 illustrates a method of transmitting a message with incremental redundancy according to at least one embodiment of the present invention; and

FIG. 4 illustrates a smart antenna according to at least on embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

According to various embodiments described below, coverage and reliability of a wireless service utilizing incremental redundancy to broadcast messages to mobile stations within a wireless coverage area is enhanced by selectively focusing a smart antenna to transmit some subframes of the broadcast messages to low coverage areas, such as areas near the sector edge or in a geographical valley. Locations of the coverage area having the lowest level of wireless coverage are determined based on various criteria and smart antennas of a base station transceiver servicing these areas are subsequently oriented to ensure that these low coverage areas reliably receive the subframes of the messages. There are some wireless services that are periodically transmitted to all, or at least several, mobile stations within a coverage area of the base station transceiver. For example, pages may be sent to such mobile stations.

According to various embodiments described below, the low-coverage areas of the wireless service area may be determined based on the region being within the coverage area but farther away from the base station such as, for example, near the edge of wireless coverage. The low coverage areas may also be determined based on observations of mobile stations on a traffic channel that require the highest levels of redundancy or power for a given level of channel fidelity. The low coverage areas may further be determined based on reports indicating idle or dormant mobile stations in these regions that were unable to decode the paging channel. After determining the low coverage areas of wireless service, the smart antenna or smart antennas at the broadcasting base station transceiver are oriented to focus on transmitting some of the incremental redundancy subframes to those low coverage areas.

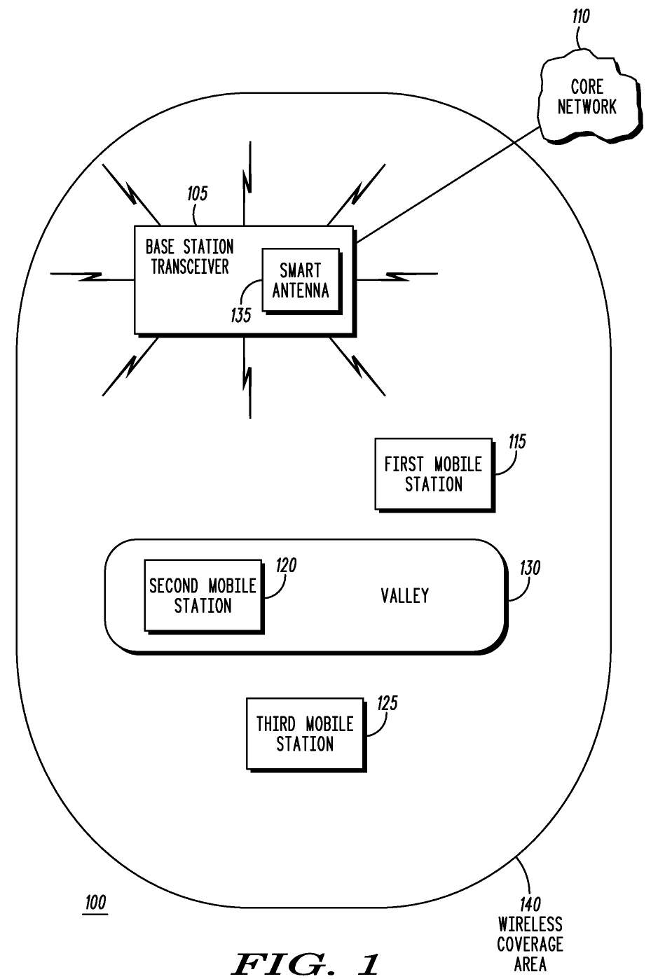

FIG. 1 illustrates a wireless system 100 according to at least one embodiment of the present invention. As shown the wireless system 100 includes a base station transceiver 105 for communicating with a core network 110 and for communicating with several mobile stations, such as a first mobile station 115, a second mobile station 120, and a third mobile station 125. As illustrated, the second mobile 120 is located within a geographical valley 130 or in some other low-coverage area, and the third mobile station 125 is near an edge of a sector or wireless coverage area 140 serviced by the base station transceiver 105.

Coverage and the capacity of the wireless system 100 for broadcast services is important, as the coverage and capacity has an impact on services such as pages, group calls, and streaming video. The base station transceiver 105 may be utilized to broadcast video, audio, and/or to transmit normal wireless call information. It is sometimes necessary for the base station transceiver 105 to transmit a paging message to the mobile stations within the wireless coverage area 140.

When transmitting on an HRPD paging channel, incremental redundancy is utilized. Incremental redundancy may increase system capacity and is typically used where the same paging message is transmitted in each of a plurality of subframes such as, for example, 16 or some other suitable number if consecutive subframes. Incremental redundancy may be utilized, for example, when there is no Automatic Repeat-reQuest (“ARQ”) feedback received from the receiving mobile station. When transmitting on the HRPD paging channel the 16 consecutive subframes are always transmitted.

The base station transceiver 105 may utilize a smart antenna 135 or multiple smart antennas to broadcast pages to the wireless coverage area 140. The smart antenna 135 may be configured to concentrate power such that certain areas of the wireless coverage area 140 receive stronger signals than other areas. For example, the valley 130 may be a low coverage area, and settings for the smart antenna 135 may be configured to focus the smart antenna 135 to transmit a strong signal to the valley 130 for at least some of the transmissions in order to increase the chances that the second mobile station 120 located within the valley 130 will reliably receive the broadcast signal and be able to decode the message.

There may be other low coverage areas with the wireless coverage area 140. For example, areas near an edge of the wireless coverage area 140, such as where the third mobile station 125 is illustrated in FIG. 1, or areas containing a concentration of tall buildings may comprise low coverage areas. Because it is more likely that mobile stations within low coverage areas may experience difficulty in receiving and decoding broadcast subframes or other information from the base station transceiver 105, the base station transceiver 105 may configure the settings for the smart antenna 135 to focus on the low coverage areas.

The base station transceiver 105 occasionally pages mobile stations within the wireless coverage area 140 to determine the locations of such mobile stations and/or determine whether any of the mobile stations have left the wireless coverage area 140. There may be other types of information that occasionally need to be broadcast to the mobile stations within the wireless coverage area 140. According to at least one embodiment of the invention, the way in which the pages are transmitted is selectively configured to increase the likelihood of the pages being reliably received by all of the mobile stations within the wireless coverage area 140. According to the method, if low coverage areas of the wireless coverage area are known, some of the 16 subframes transmitted during the incremental redundancy method may be transmitted when settings of the smart antenna 135 are focused on the low coverage areas. The reason why this is possible is because mobile stations in close proximity to the base station transceiver 105 may reliably receive the information being broadcast within just a few of the 16 transmitted consecutive subframes.

Incremental redundancy is an ARQ process. An ARQ process is an error control method for data transmission in which a receiver detects transmission errors in a message and automatically requests a retransmission from the transmitter. Incremental redundancy is an automatic repeater flash, that is, information is transmitted and if it is not understood by the receiver, more information is subsequently transmitted such as a retransmission. At that point, if the receiver still cannot determine what was transmitted, the entire 16 subframes will be resent. In a normal ARQ process, a frame is sent the first time. The same frame is then sent a second time. This is known as a retransmission.

According to HRPD or incremental redundancy, what is sent the second time may be a retransmission, or it may be something which is not exactly the same, but which basically conveys the same application level information though it may be encoded differently. The difference with HRPD or incremental redundancy is that when the receiver receives the second batch of data, it does not simply look at that second batch of data in isolation. Instead, it takes the second batch of data and combines it with what was received the first time the data was sent. Between the two batches of data, the receiver can determine whether the data was correctly received.

A paging or broadcast channel broadcasts information about when the base station transceiver 105 is transmitting and whether there are multiple mobiles that are listening to the transmission. This happens to be the case when, for example, a user's cell phone is sending a paging message. A paging message is a message that conveys to the mobile station the names of the mobile stations that currently have an incoming call. According to HRPD, the paging message is delivered, and the first time it is sent, the message is sent with little redundancy or power so only the mobile stations nearest the base station transceiver 105 can actually discern what the paging message contains. And then some number of times later, another copy of the paging message is sent. This copy may be the exact same message, or may be packaged a little bit differently, but it contains the same paging information and the packaging may or may not be different and then the receiver combines information from the two received paging messages.

Consistent coverage is desired within the wireless coverage area 140. Coverage, for the purposes of the teachings herein, means that the entire cellular area or wireless coverage area 140 is able to eventually receive the transmitted messages. The base station transceiver 105 will sometimes be in the position where it has to send a message and there are multiple mobile stations in the wireless coverage area 140 that each have to receive a paging message. For example, if the base station transceiver 105 is broadcasting some video for a television channel, incremental redundancy may be used because it helps with capacity. One of the benefits of using incremental redundancy is that it gives what is called “time diversity,” that is, by spreading out the information sent to the mobile station over 16 different messages, if the mobile station is somehow in a bad position at the time when any individual message is transmitted it will not necessarily matter because there may be better conditions at the time the other messages are sent. So the base station transceiver 105 effectively hedges its bets by spreading these messages out over time. But if the base station transceiver 105 is going to spread things out over time, then the base station transceiver 105 wants to have a receiver having the ability to combine the information received across all this time. That is why incremental redundancy is used. With broadcasting, potentially there is not necessarily any feedback from the receiver to indicate to the transmitter at what point any receiver managed to decode the message.

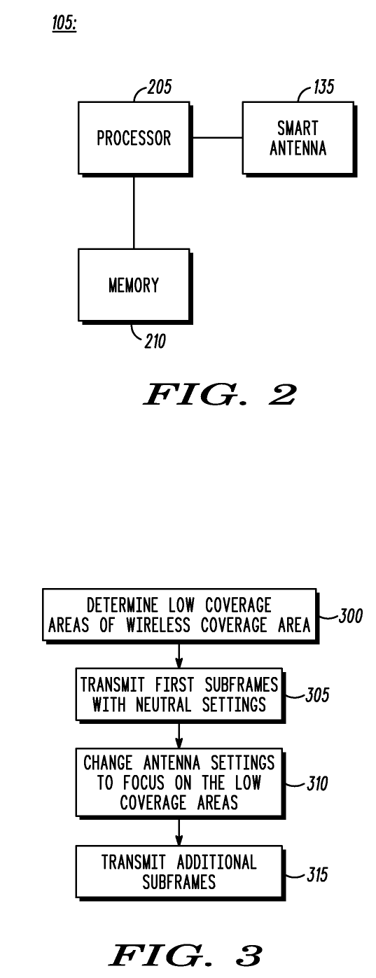

FIG. 2 is a block diagram illustration of the base station transceiver 105 according to at least one embodiment of the present invention. The base station transceiver 105 may include a processor 205, a memory 210, and a smart antenna 135. The processor may execute program code stored in the memory 210 and may configure settings for the smart antenna 135. It should be appreciated that although only a single smart antenna 135 is shown in FIG. 2, multiple smart antennas may also be utilized.

FIG. 3 illustrates a method of transmitting a message with incremental redundancy according to at least one embodiment of the present invention. The settings of the smart antenna 135 may be configured to focus on low coverage regions of the wireless coverage area 140. Prior to, or during, the transmission of the 16 different messages, low coverage areas of the wireless coverage area 140 may be determined at operation 300. The low coverage regions may be determined based on, for example, the presence of a valley 130, tall buildings, and/or the known edge of the wireless coverage area or some other geographical areas of the wireless coverage area. The low coverage regions may also be determined based on observations of mobile stations on a traffic channel, where the mobile stations require the highest levels of redundancy or power for a given level of channel fidelity. The low coverage regions may further be determined based on reports indicating idle or dormant mobile stations that are in these low coverage regions that were unable to decode the paging channel.

After the low coverage regions have been determined, the incremental redundant repeated broadcast/access channel transmits the 16 subframes. The first subframes may be transmitted with neutral settings at operation 305. These subframes may be transmitted without acknowledgement feedback. Next, at operation 310, the antenna settings of the smart antenna 135 are changed so that the smart antenna can focus on the lower coverage areas. Finally, at operation 315, additional subframes of the 16 incremental redundancy subframes are transmitted. The smart antenna settings are focused on the low coverage regions for some of the transmissions, causing the low coverage regions to receive addition signal strength. This also applies to retransmissions. During a first set of transmissions, a more neutral smart antenna setting may be utilized, and during a second set of transmissions the focus may be on the low coverage areas. It should be appreciated that in other embodiments of the present invention, the smart antenna settings may be configured such that the antenna is focused to transmit the first subframes to the low coverage areas, and the settings may be reconfigured to transmit later subframes with the neutral settings that are readily received by mobile stations in high coverage areas. It should also be appreciated that in some embodiments of the present invention the first set of transmissions is transmitted before the second set of transmissions, but in other embodiments the second set of transmission is transmitted before the first set of transmissions.

In some embodiments of the present invention, when the paging message is transmitted, the mobile station receiving the paging message may transmit an acknowledgement back to the base station transceiver 105 to indicate that the paging message was received. If, however, a particular mobile station is paged but the base station transceiver 105 does not receive a response at any time after the full 16 paging messages have been transmitted, a new set of 16 paging messages may be transmitted.

According to some embodiments of the present invention, when a message is being broadcast, an acknowledgement may be required from some mobile stations, but not from others. When the base station transceiver 105 is in the broadcast mode, where it is broadcasting to lots of mobile stations, it generally is not worthwhile to have to receive feedback for an incremental redundant transmission. Accordingly, the broadcast message may include information instructing the mobile stations receiving the paging message not to acknowledge reception. This gives the base station transceiver 105 more capacity.

A hybrid acknowledge/no acknowledge scheme may alternatively be utilized where, for example, the base station transceiver 105 is broadcasting to five mobile stations in a wireless coverage area and the base station transceiver 105 may expect to receive acknowledgements. This might become more appropriate if the base station transceiver 105 starts broadcasting and then it receives an acknowledgement from a mobile station near the base station transceiver 105. At this point, the base station transceiver 105 would know to focus on the remaining mobiles stations until an acknowledgement is received from another mobile station, at which point the base station transceiver 105 again focuses on the remaining mobile stations/regions. So the point here is that the base station transceiver 105 may not have the benefit in at least in one embodiment of that sort of feedback. Instead the base station transceiver 105 keeps sending the energy, and knows it is doing a good job of covering the energy in these areas. Statistically, whether there are mobile stations in certain areas or not, the base station transceiver 105 goes in and focuses on all areas of the wireless coverage area 140 to make sure that it covers all those areas equally.

The method described above is applicable to both access and common paging channels where the channel structure uses the incremental redundant message repetition. By implementing this method, wireless coverage and reliability may be increased substantially over current systems. Also, coverage may be maximized while minimizing other cell interference. During latter repetition transmissions, when the focus is on the wireless coverage area edge or on other low coverage areas, less noise is generated for other sectors near the base station transceiver 105. This method also yields better coverage at the wireless coverage area edge by ensuring that more power is focused on some portion of the wireless coverage area that needs it the most.

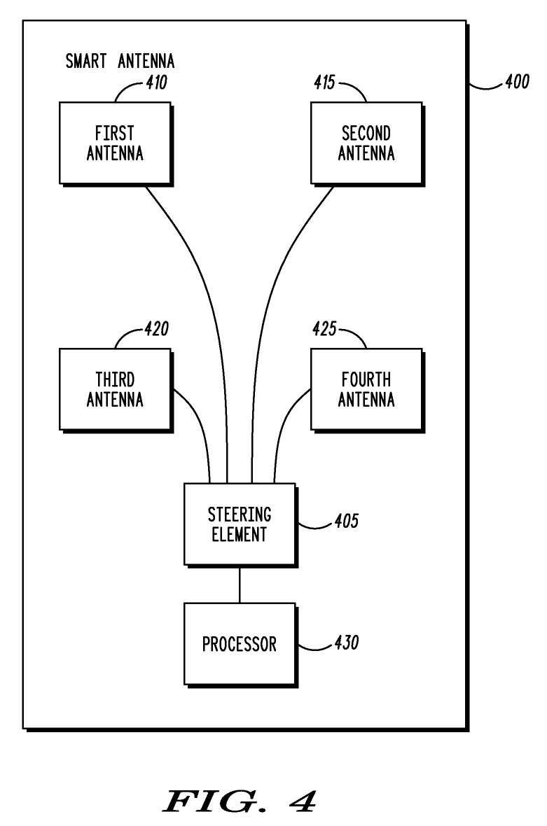

FIG. 4 illustrates a smart antenna 400, such as smart antenna 135, according to at least one embodiment of the present invention. In a simple exemplary system, the directional gain for the smart antenna 400 may be between 5 and 10 dB depending on the smart antenna settings of Side Lobe (“SL”), Phase Array (“PA”), and Adaptive Array (“AA”). The smart antenna 400 may be steered electro-magnetically by a steering element 405. In alternative embodiments, the steering element may mechanically steer the smart antenna 400. The smart antenna 400 may be comprised of two or four different antennas or antenna elements at the top of the base station transceiver, although one of ordinary skill in the art realizes that other numbers of antennas or antenna elements may be used. For example, the smart antenna 400 may include a first antenna 410, a second antenna 415, a third antenna 420, and a fourth antenna 425. The smart antenna 400 may also include a processor 430 for controlling the steering element 405.

In many cases, the various antennas of the smart antenna 400 all transmit the same thing, but sometimes the power with which each antenna transmits or the time shift with which each antenna transmits relative to each other can be controlled in a way that will cause constructive or destructive interference between their signals, so that they can cause the transmitted signals to be stronger or weaker in particular regions within an associated wireless coverage area. The smart antenna 400 may also use a motorized motor to actually tilt the entire antenna motor apparatus, up or down or so on and so forth and may change the phase. In this case, the phase of a transmitted signal may be altered by changing the delay with which one antenna transmits relative to that of an antenna that is immediately next to it.

The smart antenna 400 can utilize constructive or destructive interference when transmitting. It basically adds the result of two different signals together. If they are out of phase, for example, the signals would cancel each other, and a receiving mobile station would receive very little or no information. For example, if the base station transceiver 105 is transmitting a signal that, if it is spread out by a wide margin, it has a certain amount of coverage, but if it is squeezed it into a small area, it has a much stronger gain towards the aimed point. Smart antennas 400 can do this to focus their signals. In the event that two signals are in phase, they may add constructively to make the resultant signal very strong.

These smart antennas 400 provide an ability to focus a signal on specific areas. It is desirable to limit the amount of complexity put into these antenna elements because while more elements typically offer more flexibility, this approach usually leads to more complexity and cost. It is desirable, accordingly, to do relatively simple shifts and avoid the need for such complex and expensive antennas.

The methods described above are applicable to many services, including, for example, Plain Old Telephone Systems (“POTS”), Push-To-Talk (“PTT”), data pages, Short Message Service (“SMS”), and voicemail notifications, control channel message, channel assignments, broadcast messages, pages, and downlink maps. This method is also applicable to various protocols including, for example, Mobile Broadband Wireless Access (“MBWA”), HRPD, Universal Mobile Telecommunications System (“UMTS”), Third Generation Partnership Project Long Term Evolution (“3GPP2 LTE”), 3GPP phase 2, Orthogonal Frequency-Division Multiplexing (“OFDM”), Code division multiple access (“CDMA”), IEEE 802.16e, IEEE 802.16j, IEEE 802.20, IEEE 802.11, IEEE 802.16m, and MediaFLO.

The orientation of the smart antenna 400 may be changed over the duration of a single incremental redundant broadcast transmission based on knowledge that mobile stations near the base station transceiver 105 have completely received and decoded the transmitted message, as well as knowledge that mobile stations relatively far from the base station transceiver 400 likely have not yet received sufficient power to decode the message.

This method also applies to ad hoc networks, including cases where transmissions are directed to multiple receiving nodes such as cooperative networks. In the event that Orthogonal Frequency-Division Multiplexing (“OFDM”) is utilized, during the initial incremental redundant transmissions the smart antenna 400 can be focused more on a neutral stance to broadcast to the entire wireless coverage area.

Subsequently, redundant transmission(s)/resource consumption are avoided because the smart antenna 400 is more focused on the edge of the wireless coverage area. It may be possible to exploit the reduction in interference near the base station transceiver by transmitting to different mobile stations that are known to be near the base station transceiver during the latter transmissions. This may require that the base station transceiver be capable of transmitting the paging information via an antenna that is focused on the edge of the wireless coverage area, and simultaneously transmitting on the same frequency to a different set of users known to be near the base station transceiver.

In some embodiments of the present invention, the smart antenna 400 may be utilized to broadcast to the nearby/unloaded portion of the wireless coverage area first, and then only to the loaded portion during subsequent incremental redundant transmissions. When retransmitting, a smart antenna setting may be utilized that is appropriate for a subset of mobile stations that sent negative acknowledgements.

These teachings also apply on a dedicated channel where there is no fast feedback ARQ such as, for example, when each mobile station needs to receive the same bit rate service such as for streaming audio for a group call.

The receiver mobile stations may notch out portions of a received transmission where confidence/energy is low, for example, when the smart antenna was focusing on other portions of the wireless coverage area. Certain “must have information” such as the fact that there is a basic page may be sent to the remote portions of the wireless coverage area. Optional information indicating that not only is there a page but that the call is from a particular caller may be sent with the smart antenna focusing on areas near the base station transceiver. It may not be possible to create arbitrary intensity with a single smart antenna setting where the smart antenna has only a reasonable number of elements. However, by using the temporal shifting teachings discussed herein, it is possible to sculpt coverage to provide the most specific or optimal transmission. In general, for certain broadcast services such as a group call, smart antenna settings may be less important.

As discussed herein, during broadcast transmissions using incremental redundancy, such as HRPD, more generic smart antenna settings may be utilized during initial transmissions of incremental redundant information. The smart antenna may be particularly pointed at hard-to-reach RF locations during the subsequent incremental redundant transmissions of a particular broadcast/paging/overhead message. The rationale is that the mobile stations in good locations just under the base station transceiver have likely decoded the message after the first few incremental redundant transmissions, while the mobiles stations on the edge of the sector or in other low coverage areas are still accumulating information.

If this is done, the mobile stations at the wireless coverage area's edge and in the other low coverage areas may weigh the symbol energy received in the latter repetitions more heavily. When receiving a negative acknowledgement from a subset of the group, the smart antenna may cover the sectors where the specific mobile stations requesting the retransmission are located, instead of the entire group.

An embodiment of the present invention that alternates between transmitting to a focused problem area versus across a general area avoids the problem of a mobile station moving between the problem area and a general area in a way that is out of phase with this alternating problem, and also provides some additional time diversity benefits, but slightly worse delay, for example for users which are near the base station transceiver. This may be applicable to sectors where mobility levels are detected to be less than some threshold.

Incremental redundancy is a known method for increasing capacity and is used on HRPD and IEEE 802.16e paging channels and a downlink map where the same information is transmitted in each of N consecutive subframes. The focus is on services where there is no ARQ feedback from the receiver, that is, the HRPD paging channel always sends all 16 subframes. The purpose of the downlink map is to define the access to the downlink information. The downlink map tells each mobile station at what time changes in modulation and coding will occur. The mobile station listens to all of the data to which it is able until it reaches data for itself.

At least one embodiment of the invention is directed to a method. A low coverage region of a wireless coverage area is determined according to the method. Incremental redundant transmissions comprising first transmissions and second transmissions are transmitted. Wide beam width smart antenna settings of a smart antenna are utilized while transmitting the first transmissions. The smart antenna settings are configured to point the smart antenna at the low coverage region while transmitting the second transmissions. The first transmissions and the second transmissions are transmitted on one or more of: a dedicated channel without fast feedback Automatic Request for Retransmission (“ARQ”) and a channel having negative acknowledgment (“NAK”) feedback.

The transmitting of the incremental redundant transmissions may further comprise one of: transmitting the first transmissions prior to transmitting the second transmissions and transmitting the second transmissions prior to transmitting the first transmissions. The incremental redundant repeated transmissions may include one or more of broadcast transmissions and access channel transmissions. The low coverage region is determined based on one or more of: (a) observations of mobile stations on a traffic channel requiring highest levels of at least one of redundancy and power, for a given level of channel fidelity; (b) reports indicating at least one of an idle mobile station and a dormant mobile station in an area that was unable to decode a paging channel; (c) coverage tools; and (d) user measurements. The observations may be made in real-time. The user measurements may comprise complaints which can also be fed into the smart antenna processing engine for aiming the repeated information.

The low coverage region may also be determined based on a known location of a mobile station within the wireless coverage area and near an edge of the wireless coverage area. The incremental repeated transmissions are associated with one or more of a control channel message, channel assignment, broadcast message, page, map, Short Message Service (“SMS”), a voicemail notification, broadcast video, Plain Old Telephone Service (“POTs”), Push-To-Talk (“PTT”), and data.

The incremental repeated transmissions are transmitted according to a system comprising at least one of Universal Mobile Telecommunications System (“UMTS”), High Rate Packet Data (“HRPD”), and Mobile Broadband Wireless Access (“MBWA”), Third Generation Partnership Project Long Term Evolution (“3GPP2 LTE”), 3GPP phase 2, Orthogonal Frequency-Division Multiplexing (“OFDM”), and Code division multiple access (“CDMA”).

The configuring comprises changing an orientation of the smart antenna based on knowledge of at least a predetermined probability that a mobile station far from the base station transceiver has not received sufficient power to decode the message. The smart antenna settings are configured to point the smart antenna at areas where the subset of mobile stations is located in response to receiving a negative acknowledgement from a subset of mobile stations with the wireless coverage area. Feedback may be received from a mobile station within a region of a sector, and the smart antenna settings may be configured to point the smart antenna at other regions of the sector while transmitting the second transmissions.

At least one embodiment of the invention is directed to a system having a base station transceiver to provide wireless service to a wireless coverage area, determine a low coverage region of the wireless coverage area, and generate incremental redundant transmissions. The incremental redundant transmissions comprise first transmissions and second transmissions to be transmitted on one or more of: (a) a dedicated channel without fast feedback Automatic Request for Retransmission (“ARQ”), and (b) a channel having negative acknowledgment (“NAK”) feedback. The system also includes a smart antenna to transmit the first transmissions according to wide beam width smart antenna settings, and to point at the low coverage region to transmit the second transmissions.

The smart antenna is adapted to perform one of: transmitting the first transmissions prior to transmitting the second transmissions, and transmitting the second transmissions prior to transmitting the first transmissions. The system may include a processing element to determine the low coverage region based on one or more of: (a) observations of mobile stations on a traffic channel requiring highest levels of at least one of redundancy and power, for a given level of channel fidelity; (b) reports indicating at least one of an idle mobile station and a dormant mobile station in an area that was unable to decode a paging channel; (c) coverage tools; and (d) user measurements.

The incremental redundant repeated transmissions comprise one or more of broadcast transmissions and access channel transmissions. A configuration element may be included for configuring the smart antenna. The configuring comprises changing an orientation of the smart antenna based on knowledge of at least a predetermined probability that a mobile station far from the base station transceiver has not received sufficient power to decode the message.

The configuration element configures smart antenna settings to point the smart antenna at areas where the subset of mobile stations is located in response to receiving a negative acknowledgement from a subset of mobile stations with the wireless coverage area. The smart antenna comprises at least two steerable antennas.

At least one embodiment of the invention is directed to a base station. The base station includes a processing element to determine a low coverage region of a wireless coverage area and determine incremental repeated transmissions comprising first transmissions and second transmissions to be transmitted. The incremental repeated transmissions are transmitted on one or more of: (a) a dedicated channel without fast feedback Automatic Request for Retransmission (“ARQ”), and (b) a channel having negative acknowledgment (“NAK”) feedback. A configuration element configures a smart antenna to provide wireless service to a wireless coverage area and to transmit the first transmissions according to generic smart antenna settings, and to point the smart antenna at the low coverage region to transmit the second transmissions.

The processing element is adapted to determine the low coverage region based on one or more of: (a) observations of mobile stations on a traffic channel requiring highest levels of at least one of redundancy and power, for a given level of channel fidelity; (b) reports indicating at least one of an idle mobile station and a dormant mobile station in an area that was unable to decode a paging channel; (c) coverage tools; and (d) user measurements.

The configuration element is adapted to change an orientation of the smart antenna based on knowledge of at least a predetermined probability that a mobile station far from the base station transceiver has not received sufficient power to decode the message.

A basic idea is that when transmitting on a paging channel that uses incremental redundancy, normal mobile stations near the base station transceiver will successfully decode very quickly, whereas mobile stations near the sector edge or in other low transmission areas may barely be able to decode the message after receiving the final transmission. It is expensive to build a smart antenna that transmits more energy to the edge of the sector and less energy near the base station transceiver such that on the ground the energy level received is the same. Instead, various embodiments of the present invention provide that during some of the incremental redundancy frames a normal smart antenna setting is used, but in other transmissions, the focus of the antenna is specifically on the edge of the sector or other low coverage areas, for example, by using a simple antenna tilt. In this way, with a simple antenna design generating less interference in requiring a smaller power amplifier, better or more uniform coverage may be achieved near the edge of the sector or in other low coverage areas.

Some of the mobile stations in the wireless coverage area may take until the last incremental redundant subframe in order to decode the paging message. Furthermore, after receiving the paging message, and decoding the message, if the mobile station's identifier is not listed, then the receiving mobile station does not need to do anything else, because the network cannot determine whether the mobile station sent it off or not. Current methods use the same antenna settings over the duration over all of these incremental redundant transmissions. This results in more than enough power being used for the mobile stations that are near the base station transceiver or that otherwise receive good coverage (which might comprise, for example, reception with 98 or 99% reliability). The mobile stations in the low coverage areas, however, have much more reliability such as, for example, 95% reliability. Accordingly, by selectively steering a smart antenna during transmission of a message according to an incremental redundancy scheme as discussed herein, the message may be more efficiently and reliably transmit messages to mobile stations within the wireless coverage area.

Those skilled in the art will recognize and appreciate that these teachings can be applied in various ways and are readily leveraged in a variety of application settings. It will also be understood and appreciated that these teachings can be relatively economically facilitated and are highly scalable in practice.

Those skilled in the art will recognized that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method, comprising:
determining a low coverage region of a wireless coverage area;
transmitting incremental redundant transmissions comprising first transmissions and second transmissions;
utilizing wide beam width smart antenna settings of a smart antenna while transmitting the first transmissions;
configuring the smart antenna settings to point the smart antenna at the low coverage region while transmitting the second transmissions; and
wherein the first transmissions and the second transmissions are transmitted on one or more of a dedicated channel without fast feedback Automatic Request for Retransmission (“ARQ”) and a channel having negative acknowledgment (“NAK”) feedback.

2. The method of claim 1, wherein the transmitting incremental redundant transmissions further comprises one of: transmitting the first transmissions prior to transmitting the second transmissions, and transmitting the second transmissions prior to transmitting the first transmissions.

3. The method of claim 1, wherein the incremental redundant repeated transmissions comprise one or more of broadcast transmissions and access channel transmissions.

4. The method of claim 1, wherein the low coverage region is determined based on one or more of:
observations of mobile stations on a traffic channel requiring highest levels of at least one of redundancy and power, for a given level of channel fidelity;
reports indicating at least one of an idle mobile station and a dormant mobile station in an area that was unable to decode a paging channel;
coverage tools; and
user measurements.

5. The method of claim 4, wherein the low coverage region is further determined based on a known location of a mobile station within the wireless coverage area and near an edge of the wireless coverage area.

6. The method of claim 1, wherein the incremental repeated transmissions are associated with one or more of a control channel message, channel assignment, broadcast message, page, map, Short Message Service (“SMS”), a voicemail notification, broadcast video, Plain Old Telephone Service (“POTs”), Push-To-Talk (“PTT”), and data.

7. The method of claim 1, wherein the incremental repeated transmissions are transmitted according to a system comprising one or more of Universal Mobile Telecommunications System (“UMTS”), High Rate Packet Data (“HRPD”), and Mobile Broadband Wireless Access (“MBWA”), Third Generation Partnership Project Long Term Evolution (“3GPP2 LTE”), 3GPP phase 2, Orthogonal Frequency-Division Multiplexing (“OFDM”), and Code division multiple access (“CDMA”).

8. The method of claim 1, wherein the configuring comprises changing an orientation of the smart antenna based on knowledge of at least a predetermined probability that a mobile station far from the base station transceiver has not received sufficient power to decode the message.

9. The method of claim 1, wherein in response to receiving a negative acknowledgement from a subset of mobile stations with the wireless coverage area, the smart antenna settings are configured to point the smart antenna at areas where the subset of mobile stations is located.

10. The method of claim 1, further comprising receiving feedback from a mobile station within a region of a sector, and further configuring the smart antenna settings to point the smart antenna at other regions of the sector while transmitting the second transmissions.

11. A system, comprising:
a base station transceiver to provide wireless service to a wireless coverage area, determine a low coverage region of the wireless coverage area, and generate incremental redundant transmissions comprising first transmissions and second transmissions to be transmitted on one or more of a dedicated channel without fast feedback Automatic Request for Retransmission (“ARQ”) and a channel having negative acknowledgment (“NAK”) feedback; and
a smart antenna to transmit the first transmissions according to wide beam width smart antenna settings, and to point at the low coverage region to transmit the second transmissions.

12. The system of claim 11, further comprising a processing element to determine the low coverage region based on one or more of:
observations of mobile stations on a traffic channel requiring highest levels of at least one of redundancy and power, for a given level of channel fidelity;
reports indicating at least one of an idle mobile station and a dormant mobile station in an area that was unable to decode a paging channel;
coverage tools; and
user measurements.

13. The system of claim 11, wherein the incremental redundant repeated transmissions comprise one or more of broadcast transmissions and access channel transmissions.

14. The system of claim 11, further comprising a configuration element for configuring the smart antenna, the configuring comprising changing an orientation of the smart antenna based on knowledge of at least a predetermined probability that a mobile station far from the base station transceiver has not received sufficient power to decode the message.

15. The system of claim 14, wherein in response to receiving a negative acknowledgement from a subset of mobile stations with the wireless coverage area, the configuration element configures smart antenna settings to the point the smart antenna at areas where the subset of mobile stations is located.

16. The system of claim 14, wherein the smart antenna comprises at least two steerable antennas.

17. A base station transceiver, comprising:
a processing element to determine a low coverage region of a wireless coverage area and determine incremental repeated transmissions comprising first transmissions and second transmissions to be transmitted on one or more of a dedicated channel without fast feedback Automatic Request for Retransmission (“ARQ”) and a channel having negative acknowledgment (“NAK”) feedback; and
a configuration element to configure a smart antenna to provide wireless service to a wireless coverage area and to transmit the first transmissions according to generic smart antenna settings, and to point the smart antenna at the low coverage region to transmit the second transmissions.

18. The base station transceiver of claim 17, wherein the processing element is adapted to determine the low coverage region based on one or more of:
observations of mobile stations on a traffic channel requiring highest levels of at least one of redundancy and power, for a given level of channel fidelity;
reports indicating at least one of an idle mobile station and a dormant mobile station in an area that was unable to decode a paging channel;
coverage tools; and
user measurements.

19. The base station transceiver of claim 17, wherein the configuration element is adapted to change an orientation of the smart antenna based on knowledge of at least a predetermined probability that a mobile station far from the base station transceiver has not received sufficient power to decode the message.

20. The base station transceiver of claim 17, wherein the smart antenna is adapted to perform one of: transmitting the first transmissions prior to transmitting the second transmissions, and transmitting the second transmissions prior to transmitting the first transmissions.
